(19) United States
(12) Patent Application Publication
(10) Pub. No.: US 2016/0213135 A1
(43) Pub. Date: Jul. 28, 2016

(54) RETRACTABLE APPLICATOR SYSTEM

(71) Applicant: Evangelia Parlionas, College Point, NY (US)

(72) Inventor: Evangelia Parlionas, College Point, NY (US)

(21) Appl. No.: 14/839,823

(22) Filed: Aug. 28, 2015

Related U.S. Application Data
(60) Provisional application No. 62/042,941, filed on Aug. 28, 2014.

(51) Int. Cl. A45F 5/00; B05B 15/06; B05B 11/00; A45D 40/18; A45F 5/02

(52) U.S. Cl. CPC A45F 5/004; A45D 40/18; A45F 5/02; B05B 11/3042; B05B 15/061; A45F 2005/006

(57) ABSTRACT

A system for retractably securing a hygeine product to a garment of a user, the system having an applicator forming an interior space therein containing a hygeine product substance, the applicator having a base portion on a first end and a dispensing portion on a second end wherein said interior space cannot be removed from the base portion, and a retractor assembly for removably mounting the applicator to a garment of the user in a manner that permits selective movement of the applicator away from the body of the user; wherein the retractor assembly is connected directly to the base portion of the applicator such that when the applicator is freely hanging below the retractor assembly, said base portion is positioned closer to the retractor assembly than the dispensing portion and the dispensing portion is positioned below the base portion.

This application claims priority from U.S. Provisional Application No. 62/042,941 filed on Aug. 28, 2014.

### BACKGROUND OF THE INVENTION

1. Field of the Invention

The present invention relates to retractable article holders and more particularly pertains to a retractable applicator system for retractably securing a hygeine product to a garment of a user.

2. Description of the Prior Art

Anti bacterial hygiene products are a staple of most homes and businesses in the modern world. In order to be used for optimal efficacy, the product needs to be readily available for use and an appropriate amount dispensed for the user. The combination of a retractor assembly coupled to an antibacterial hygiene product which can, in an embodiment, dispense a predetermined amount of product, is novel as compared to the prior art.

One significant advantage of the present invention is that is allows the user to position the hygiene product in close proximity and/or in a convenient location so that the product can be easily found when needed while inhibiting the inadvertent loss of the product dispenser.

Another significant advantage of the present invention is that in one embodiment, it allows the user to dispense a pre-determined amount of product, thereby eliminating waste of the hygiene product.

### SUMMARY OF THE INVENTION

The present invention is directed to a system for retractably securing a hygiene product to a garment of a user, the system comprising an applicator forming an interior space therein containing a hygiene product substance, the applicator comprising a base portion on a first end and a dispensing portion on a second end, wherein said interior space cannot be removed from said base portion; and a retractor assembly for removably mounting say applicator to a garment of the user in a manner that permits selective movement of said applicator away from the body of the user, wherein said retractor assembly is connected directly to the base portion of the applicator such that when said applicator is freely hanging below said retractor assembly, said base portion is positioned closer to said retractor assembly than said dispensing portion and said dispensing portion is below said base portion.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a perspective view of a first embodiment of the new retractable hygeine product dispenser system according to the present invention showing the lanyard extended from the housing.

### DESCRIPTION OF PREFERRED EMBODIMENTS

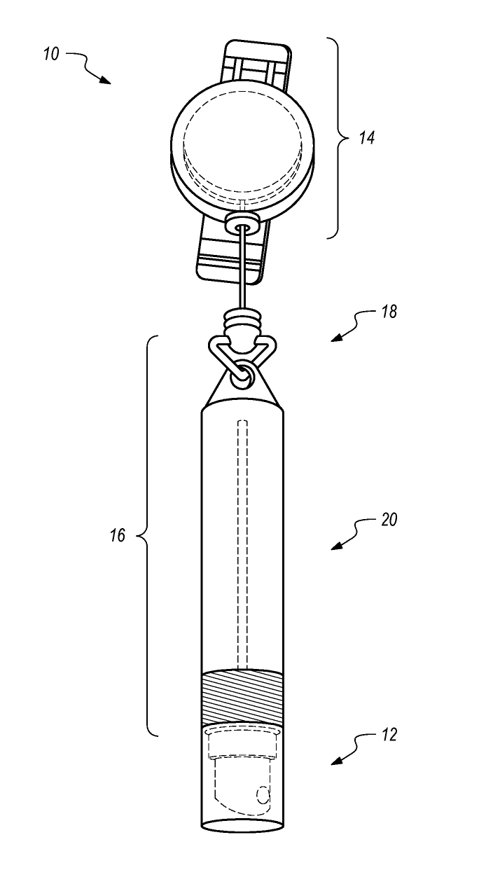

With reference now to FIG. 1, a new retractable applicator system embodying the principles and concepts of the present invention and generally designated by the reference numeral 10 will be described.

As illustrated in FIG. 1, the retractable applicator system 10 generally comprises an applicator 12 for containing and applying an antibacterial substance to the user and a retractor assembly 14 for removably mounting the applicator 12 to a garment of the user.

The applicator 12 may include a base portion 16 for containing the anti-bacterial substance. The base portion 16 may comprise a base wall 18 and a perimeter wall 20. In the embodiment depicted in FIG. 1, the portions of the perimeter wall 20 converge together to form the base wall 18. In an alternate embodiment, the base portion 16 forms a container for the a substance, and the perimeter wall 18 also converges to form the base wall 18. In a 3rd embodiment, the perimeter wall 20 extends substantially orthogonally from the base wall 18. The base wall 18 and the perimeter wall 20 define an interior space 22 for receiving the lip care substance. The interior space 22 may also removably receive a portion of an anti-bacterial substance container that is inserted into the base portion when full and removed from the base portion when empty. Further, the base portion may forms the anti-bacterial substance container itself, and the base portion 16 has a dispensing opening 24 that permits dispensing of the anti-bacterial substance from the interior of the base member. In the alternate embodiments, the base portion 16 may be removed from the retractor assembly 14 when all of the anti-bacterial substance has been removed from the container, and another anti-bacterial substance container is mounted on the retracting assembly. In the alternate embodiments of, the base portion 16 also forms the container for the lip care substance.

The applicator 12 may further include a cap portion 26 that is removably coupled to the perimeter wall 20 of the base portion 16 opposite of the base wall 18. In FIG. 1, and other embodiments, the cap portion 26 removably covers the dispensing opening 24 of the base portion 16 to prevent inadvertent dispensing of the anti-bacterial substance from the interior when the cap portion 26 is coupled to the perimeter wall 20 of the base portion 16.

The retractor assembly 14 of the invention permits selective movement of the applicator 12 away from the garment on the body of the user.

The retractor assembly 14 may include a housing 30 defining a receiving space 32 with an aperture 34 extending through the housing 30. The aperture 34 is in communication with the receiving space 32 of the housing 30 and the exterior of the housing. Illustratively, the housing 30 may be substantially disk shaped to inhibit the housing 30 from snagging on the garment of the user, although other shapes may also be employed. The housing 30 may comprise a back wall 36, a front wall 38 and a peripheral wall 40 extending between the front wall 38 and the back wall 36. As shown in FIG. 1, the peripheral wall 40 may be annular in shape. The aperture 34 may be located in, and extend through, the peripheral wall 40.

The retractor assembly 14 further comprises a spool 42 mounted on the housing 30 with the spool 42 being positioned in the receiving space 32 of the housing 30. The spool 42 is positioned between the front wall 38 and the back wall 36 of the housing 30.

The retractor assembly 14 may further comprise a lanyard member 44 coupled to the spool 42. A portion of the lanyard member 44 is extendable from the receiving space 32 through the aperture 34 of the housing 30 when the lanyard member 44 is pulled by the user. The spool 42 retracts a portion of the lanyard member 44 into the receiving space 32 when the lanyard member 44 is released by the user, thus maintaining a degree of retracting tension on the lanyard at all times. The lanyard may comprise a substantially flexible material to facilitate winding of the lanyard member 44 onto the spool 42 and to permit the user to direct the applicator 12 to the desired location (such as adjacent the lips) for the application of the lip care substance.

The retractor assembly 14 may further comprise a securing member 46 coupled to the lanyard member 44 opposite the housing 30. The securing member 46 is removably coupled to the base portion 14 of the applicator 12 to secure the applicator 12 to the retractor assembly 28. The securing member 46 may comprise a strap portion 48 extending through the bore 26 of the base portion 14 of the applicator 12 to secure the applicator 12 to the lanyard member 44. The strap portion 48 may comprise a strip of flexible material permitting the planar portion 48 to bend through the bore 26 of the applicator 12. The strap portion 48 has a proximal end 50 and a distal end 52. The proximal end 50 is coupled to the lanyard member 44. The distal end 52 is extended through the bore 26 of the applicator 12 and secured to a medial section 54 of the strap portion 48 to secure the applicator 12 to the lanyard member 44. The securing member 46 may comprise a first fastener portion 56 and a second fastener portion 58. The first fastener portion 56 is coupled to the distal end 52 of the strap portion 48. The second fastener portion 58 is coupled to the medial section 54 of the strap portion 48. The first fastener portion 56 is complimentary to the second fastener portion 58 to allow the distal end 52 of the strap portion 48 to be secured to the medial section 54 of the strap portion 48.

In an alternate embodiment, the securing member 46 may comprise a chain 60 being secured to the lanyard member 44. The chain 60 extends between the base wall 16 of the applicator 12 and the lanyard member 44 to secure the applicator 12 to the lanyard member 44. The chain 60 may be coupled to the base wall 16 with a screw or adhesive (or other suitable fastening means) to ensure that the chain 60 is secured to the applicator 12.

The retractor assembly 40 may further comprise a clip member 62 coupled to the back wall 36 of the housing 30 of the reel member. The clip member 62 may be self-biasing for compressing or pinching a portion of a garment of the user between the clip member 62 and the back wall 36 of the housing 30 to secure the retractor assembly 28 to the user. The clip member 62 may comprise a first end portion 64 coupled to the back wall 36 proximate the peripheral wall 40 of the housing 30 and extending back over the back wall 36. The clip member 62 may comprise a second end portion 66 that extends from the first end portion 64 opposite the peripheral wall 40. The second end portion 66 may extend in an arcuate manner towards the back wall 36 from the first end portion 64 and then extend in an arcuate manner away from the back wall 36 opposite the first end portion 64 to permit the garment to be removably inserted between the second end portion 66 and the back wall 36 to permit the second end portion 66 of the clip member 62 to compress the garment against the back wall 36.

In use, the user inserts a portion of a garment that the user is wearing between the second end portion 66 of the clip member 62 and the back wall 36 of the housing 30 to secure the retractor assembly 28 to the garment. The user is then able to grip the applicator 12 and draw the lanyard out of the housing 30 to position the applicator 12 in a desired location. The cap portion 24 can then be removed to allow the lip care substance to be dispensed from the dispensing opening 22 to the lips. When the user has finished dispensing the lip care substance the cap portion 24 is returned to the base portion 14 of the applicator 12. The user can then release the applicator 12 and the spool 42 will retract a portion the lanyard back into the housing 30 and thereby draw the applicator 12 back to the housing 30 which allows the user to have the lip care product in a convenient location.

With respect to the above description then, it is to be realized that the optimum dimensional relationships for the parts of the invention, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system for retractably securing a hygeine product to a garment of a user, the system comprising: an applicator forming an interior space therein containing a hygeine product substance; said applicator comprising a base portion on a first end and a dispensing portion on a second end wherein said interior space cannot be removed from said base portion; and a retractor assembly for removably mounting said applicator to a garment of the user in a manner that permits selective movement of said applicator away from the body of the user; wherein said retractor assembly is connected directly to the base portion of the applicator such that when said applicator is freely hanging below said retractor assembly, said base portion is positioned closer to said retractor assembly than said dispensing portion and said dispensing portion is positioned below said base portion.

2. The system as set forth in claim 1, wherein said base portion comprises a base wall and a perimeter wall, said perimeter wall extending substantially orthogonally from said base wall, said base wall and said perimeter wall defining said interior space.

3. The system as set forth in claim 1, wherein said dispensing portion has a dispensing opening for dispensing the anti bacterial substance from said interior of said base portion.

4. The system as set forth in claim 3, wherein said applicator comprises a cap portion being removably coupled to said dispensing portion, said cap portion removably covering said dispensing opening of said dispensing portion for inhibiting, contact between the hygeine product and the garment of the user when said cap portion is covering said dispensing opening.

5. The system as set forth in claim 1, wherein the base portion defines a bore extending through said base portion for facilitating coupling of said retractor assembly to said applicator, said bore extending substantially perpendicular to a longitudinal axis of said base portion, said base portion inhibiting communication between said bore and said interior space.

6. The system as set forth in claim 1, wherein said retractor assembly comprises a housing defining a receiving space and an aperture extending through said housing, said aperture being in communication with said receiving space of said housing.

7. The system as set forth in claim 6, wherein said housing is substantially disk shaped to inhibit said housing being inadvertently snagged on the garment of the user.

8. The system as set forth in claim 6, wherein said housing comprises a back wall, a front wall and a peripheral wall, said peripheral wall extending between said front wall and said back wall, said aperture extending through said peripheral wall.

9. The system as set forth in claim 6, wherein a lanyard member is extendable from said receiving space through said aperture of said housing when said lanyard member is pulled by the user.

10. The system as set forth in claim 9, wherein said retractor assembly comprises a spool mounted to said housing such that said spool is positioned in said receiving space of said housing, said spool retracting a portion of said lanyard member into said receiving space when said lanyard member is released by the user.

11. The system as set forth in claim 9, wherein said lanyard comprises a substantially flexible material to allow the user to direct said applicator to a desired location.

12. The system as forth in claim 9, wherein said retractor assembly comprises a securing member being coupled to said lanyard member opposite said housing, said, securing member being removably coupled to said applicator to secure said applicator to said retractor assembly.

13. The system as set forth in claim 12, wherein said securing member comprises a planar portion extending through a bore extending through said applicator to secure said applicator to said lanyard member.

14. The system as set forth in claim 13, wherein a planar portion comprises a strip of flexible material permitting said planar portion to bend through said bore of said applicator.

15. The system as set forth in claim 13, wherein said planar portion has a proximal end and a distal end, said proximal end being coupled to said lanyard member, said distal end being extended through said bore of said applicator and secured to a medial section of said planar portion to secure said applicator to said lanyard member.

16. The system as set forth in claim 15, wherein said securing member comprises a first fastener portion and a second fastener portion, said first fastener portion being coupled to said distal end of said planar portion, said second fastener portion being coupled to said medial section of said planar portion, said first fastener portion being complimentary to said second fastener portion to allow said distal end of said planar portion to be secured to said medial section of said planar portion.

17. The system as set forth in claim 12, wherein said securing member comprises a chain being secured to said lanyard member, said chain being coupled to said base wall of said applicator to secure said applicator to said lanyard member.

18. The system as set forth in claim 6, wherein said retractor assembly comprises a clip member being coupled to said housing, said clip member being self-biasing for compressing a portion, of a garment of the user between said clip member and said housing to secure said retractor assembly to the user.
